(19) United States
(12) Patent Application Publication
(10) Pub. No.: US 2011/0279515 A1
(43) Pub. Date: Nov. 17, 2011

(54) AQUEOUS INKJET INK

(75) Inventors: Maiko Yoshida, Shizuoka-ken (JP); Ryozo Akiyama, Shizuoka-ken (JP); Takafumi Hara, Shizuoka-ken (JP); Chie Tonohiro, Shizuoka-ken (JP); Atsushi Kubota, Shizuoka-ken (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/097,697

(22) Filed: Apr. 29, 2011

Related U.S. Application Data
(60) Provisional application No. 61/333,366, filed on May 11, 2010.

(51) Int. Cl. B41J 2/015; C09D 11/02

(52) U.S. Cl. 347/20; 106/31.13; 106/31.86

(57) ABSTRACT

According to one embodiment, an aqueous inkjet ink includes a color material, water as a first liquid, propylene glycol as a second liquid, and a compound represented by the following general formula (PEG) or a compound represented by the following general formula (PGC) as a third liquid. The aqueous inkjet ink has a water activity of 0.85 or less.

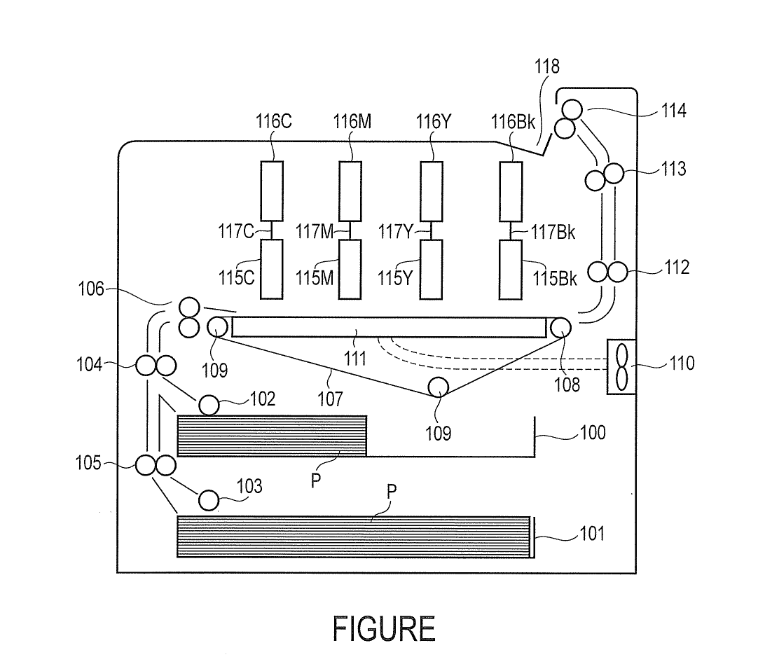

R^{a}—O—(CH₂CH₂O)ₙ—H (PEG)

In the formula, R^{a} represents H or CH₃, and n represents 3 to 14.

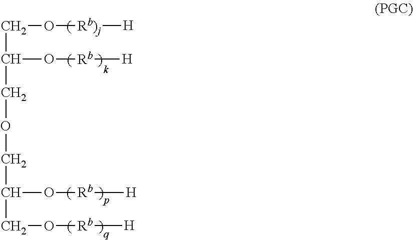

In the formula, R^{b} represents a group selected from CH₂CH₂O and CH₂CHCH₃O, and j, k, p, and q may be the same or different, and represent an integer of 1 or more, and satisfy the formula: 4≦j+k+p+q≦8.

### CROSS-REFERENCE TO RELATED APPLICATION

This application is based upon and claims the benefit of priority from U.S. Provisional Application No. 61/333,366 filed on May 11, 2010, the entire contents of which are incorporated herein by reference.

### FIELD

Embodiments described herein relate generally to an aqueous inkjet ink.

### BACKGROUND

As a color material in an aqueous inkjet ink, a water-soluble dye is generally used. Recently, an aqueous inkjet ink in which a pigment is dispersed in an aqueous medium is proposed.

The aqueous inkjet ink using an aqueous medium should have a property suitable for ejection from an inkjet head. The aqueous inkjet ink for use in printing on a paper medium is required to suppress deformation of the paper medium such as curling or cockling as much as possible.

### BRIEF DESCRIPTION OF THE DRAWINGS

The single FIGURE is a view showing an exemplary inkjet printing apparatus to which an embodiment is applied.

### DETAILED DESCRIPTION

In general, according to one embodiment, an aqueous inkjet ink contains: a color material; water as a first liquid; propylene glycol as a second liquid; and a compound represented by the following general formula (PEG) or a compound represented by the following general formula (PGC) as a third liquid. The aqueous inkjet ink has a water activity of 0.85 or less.

R^{a}—O—(CH₂CH₂O)ₙ—H (PEG)

In the formula, R^{a} represents H or CH₃; and n represents 3 to 14.

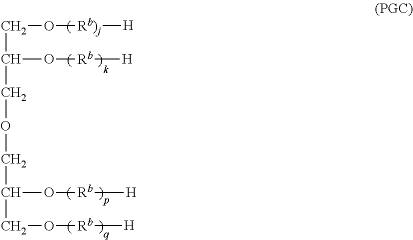

In the formula, R^{b} represents a group selected from CH₂CH₂O and CH₂CHCH₃O; and j, k, p, and q may be the same or different, and represent an integer of 1 or more, and satisfy the formula: 4≦j+k+p+q≦8.

Hereinafter, embodiments will be specifically described.

In an inkjet printing apparatus shown in the FIGURE, paper cassettes 100 and 101 contain paper P of different sizes, respectively. A paper feed roller 102 or 103 takes out the paper P in response to the selected paper size from the paper cassette 100 or 101 and conveys the paper P to conveying roller pairs 104 and 105 and a resist roller pair 106.

A tension is given to a conveying belt 107 by a driving roller 108 and two driven rollers 109. Through-holes are provided at predetermined intervals in the conveying belt 107, and for the purpose of adsorbing the paper P onto the conveying belt 107, a negative pressure chamber 111 connected to a fan 110 is installed in the inside of the conveying belt 107. Conveying roller pairs 112, 113, and 114 are installed in the downstream of the paper conveying direction of the conveying belt 107.

Four rows of inkjet heads which eject inks onto paper according to image data are disposed above the conveying belt 107. An inkjet head 115C which ejects a cyan (C) ink, an inkjet head 115M which ejects a magenta (M) ink, an inkjet head 115Y which ejects a yellow (Y) ink, and an inkjet head 115Bk which ejects a black (Bk) ink are arranged in this order from the upstream. Further, these inkjet heads 115C, 115M, 115Y, and 115Bk are provided with a cyan (C) ink cartridge 116C, a magenta (M) ink cartridge 116M, a yellow (Y) ink cartridge 116Y, and a black (Bk) ink cartridge 116Bk, respectively, each of which contains an ink of each color. These cartridges are connected to the inkjet heads via tubes 117C, 117M, 117Y, and 117Bk, respectively.

An image forming operation of the inkjet printing apparatus having such a structure will be described below.

First, image processing for printing by an image processing unit (not shown) is initiated, and image data for printing are transferred to the respective inkjet heads 115C, 115M, 115Y, and 115Bk. Also, the paper P of a selected paper size is taken out one by one from the paper cassette 100 or 101 by the paper feed roller 102 or 103 and conveyed to the conveying roller pairs 104 and 105 and the resist roller pair 106. The resist roller pair 106 corrects a skew of the paper P and conveys the paper P at a given timing.

The negative pressure chamber 111 draws air through the holes of the conveying belt 107, and therefore, the paper P is conveyed in a state of being adsorbed onto the conveying belt 107 on a lower side of the inkjet heads 115C, 115M, 115Y, and 115Bk. In this manner, the respective inkjet heads 115C, 115M, 115Y, and 115Bk and the paper P can keep a fixed space from each other. The ink of each color is ejected from each of the inkjet heads 115C, 115M, 115Y, and 115Bk in synchronization with the timing for conveying the paper P from the resist roller pair 106. Thus, a color image is formed at a desired position on the paper P. The paper P having an image formed thereon is discharged to a paper discharge tray 118 by the conveying roller pairs 112, 113, and 114.

Each ink cartridge stores an aqueous inkjet ink according to one embodiment.

The aqueous inkjet ink according to this embodiment contains an aqueous liquid mixture and a color material, and has a water activity (aw) of 0.85 or less. The water activity is a numerical value indicating the percentage of free water in a material, and is generally used as an index of the shelf stability of food. The free water is water which easily evaporates due to a change in environmental temperature or humidity, and it is known that the water activity is a factor that affects the growth of microorganisms in food.

The present inventors studied the degree of deformation of paper by performing printing on the paper with various aqueous inkjet inks using a water activity as an index. As a result, it was found that an effect of suppressing deformation of paper is increased when the water activity of the aqueous inkjet ink is a predetermined value or less. In this specification, the water activity is defined as follows.

Water activity=(water vapor pressure of ink)/(water vapor pressure of pure water)

The aqueous inkjet ink having a water activity of 0.85 or less has an excellent ability to suppress curling of paper and suppresses deformation of paper immediately after printing. Deformed paper is not smoothly conveyed in an inkjet printing apparatus. The paper is not neatly discharged, and sometimes paper cannot be conveyed and a paper jam is caused in some cases. The occurrence of such a problem is particularly prominent when the printing speed is increased.

The aqueous inkjet ink according to one embodiment has excellent ability to suppress deformation of paper, and therefore, there is no fear that paper after printing cannot be conveyed. As a result, it became possible to use the aqueous inkjet ink in high-speed printing at a printing rate of 50 ppm (page per minute) or more. The water activity of the aqueous inkjet ink according to one embodiment is 0.85 or less and preferably 0.75 or less.

The water activity of the aqueous inkjet ink can be measured using, for example, Aqua Lab CX-3TE (manufactured by DECAGON Co.) by means of a chilled mirror dew point measuring method.

The aqueous inkjet ink according to this embodiment contains a liquid mixture containing three types of liquids and a color material. The first liquid is water, the second liquid is propylene glycol, and the third liquid is a compound represented by the following general formula (PEG) or a compound represented by the following general formula (PGC).

R^{a}—O—(CH₂CH₂O)ₙ—H (PEG)

In the formula, R^{a} represents H or CH₃; and n represents 3 to 14.

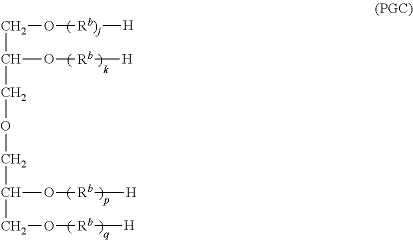

In the formula, R^{b} represents a group selected from CH₂CH₂O and CH₂CHCH₃O; and j, k, p, and q may be the same or different, and represent an integer of 1 or more, and satisfy the formula: 4≦j+k+p+q≦8.

By using such a liquid mixture, the aqueous inkjet ink according to this embodiment can suppress deformation of a paper medium such as curling or cockling as much as possible.

The paper medium as used herein generally refers to a medium made of paper to be used for printing. The paper medium is broadly divided into coated paper coated with a material for increasing print properties such as art paper or coat paper and non-coated paper to be used for utilizing the properties of paper itself. The paper medium is applied to a variety of uses such as books, documents, newspapers, packages, printer sheets, etc. The paper medium also includes corrugated cardboard, containers made of paper, and thick paper such as cardboard. For example, so-called plain paper such as copy paper to be used in a copier or a printer for office or home use is a typical paper medium.

The content of water as the first liquid is preferably from 40 to 60% by mass of the total amount of the ink. If water is contained in such an amount, deformation of paper can be suppressed, and also the ejection performance from an inkjet head is not deteriorated. Since water is contained in an amount of at least 40% by mass of the total amount of the ink, the lower limit of the water activity in the aqueous inkjet ink according to this embodiment is generally about 0.7. It is preferred to appropriately set the content of water so that the water activity is 0.85 or less when the second liquid and the third liquid are mixed in the ink. As the water, for example, pure water can be used.

Propylene glycol as the second liquid has an action to decrease the water activity of the ink. When propylene glycol is added to the ink, the molar fraction of water in the ink is decreased, resulting in decreasing the water activity. The amount of propylene glycol as the second liquid is preferably from 25 to 40% by mass of the total amount of the ink.

The third liquid is a compound represented by the following general formula (PEG) or a compound represented by the following general formula (PGC).

R^{a}—O—(CH₂CH₂O)ₙ—H (PEG)

In the formula, R^{a} represents H or CH₃; and n represents 3 to 14.

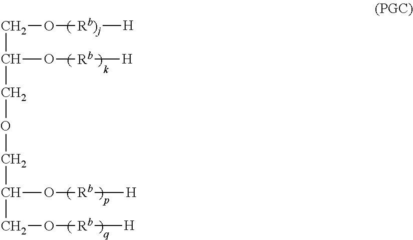

In the formula, R^{b} represents a group selected from CH₂CH₂O and CH₂CHCH₃O; and j, k, p, and q may be the same or different, and represent an integer of 1 or more, and satisfy the formula: 4≦j+k+p+q≦8.

Such a third liquid has a high effect of decreasing the water activity per number of moles. By incorporating the third liquid along with propylene glycol as the second liquid, the water activity of the aqueous inkjet ink according to this embodiment can be more effectively decreased. The second liquid and the third liquid are collectively called a water activity decreasing agent.

Examples of the compound represented by the above general formula (PEG) include PEG200 and PEG400 (all of which are manufactured by Sanyo Chemical Industries, Ltd.), and MPG and MTG (all of which are manufactured by Nippon Nyukazai Co., Ltd.).

Examples of the compound represented by the above general formula (PGC) include SC-P400 and SC-E450 (all of which are manufactured by Sakamoto Yakuhin Kogyo Co., Ltd.).

The amount of the third liquid is preferably from 5 to 20% by mass of the total amount of the ink, and more preferably from 9 to 20% by mass of the total amount of the ink.

The ability to decrease the water activity of the compound to be used as the third liquid varies depending on the structure thereof or the like. For example, in the case of the compound represented by the general formula (PEG), when the value of n is increased, the ability to decrease the water activity is decreased.

In consideration of these, water as the first liquid and the second and third liquids as the water activity decreasing agent may be combined by determining appropriate amounts such that the finally obtained aqueous inkjet ink has a water activity of 0.85 or less. The aqueous inkjet ink according to this embodiment can be prepared by, for example, adding the color material to the liquid mixture containing the first, second, and third liquids.

As the color material, either of a dye and a pigment may be used. As the dye, for example, any of a variety of dyes to be used in an inkjet ink such as a direct dye, an acid dye, a food dye, a reactive dye, and a disperse dye can be used.

Specific examples thereof include the following dyes: C.I. Direct Yellow 8, C.I. Direct Yellow 11, C.I. Direct Yellow 24, C.I. Direct Yellow 26, C.I. Direct Yellow 27, C.I. Direct Yellow 28, C.I. Direct Yellow 33, C.I. Direct Yellow 44, C.I. Direct Yellow 50, C.I.

Direct Orange 6, C.I. Direct Orange 8, C.I. Direct Orange 29, C.I. Direct Orange 102, C.I. Direct Red 1, C.I. Direct Red 2, C.I. Direct Red 4, C.I. Direct Red 13, C.I. Direct Red 17, C.I. Direct Red 20, C.I. Direct Red 33, C.I. Direct Red 37, C.I. Direct Red 44, C.I. Direct Red 46, C.I. Direct Red 62, C.I. Direct Red 75, C.I. Direct Blue 1, C.I. Direct Blue 2, C.I. Direct Blue 6, C.I. Direct Blue 15, C.I. Direct Blue 22, C.I. Direct Blue 25, C.I. Direct Blue 76, C.I. Direct Blue 77, C.I. Direct Blue 86, C.I. Direct Blue 108, and C.I. Direct Blue 120.

The content of the dye in the ink is preferably within a range of from 2 to 20% by mass of the total amount of the ink. If the content thereof is within this range, a printed matter having a necessary image density can be formed without causing any disadvantage with respect to the storage stability or ejection performance of the ink.

If a pigment is used as the color material, the water resistance and light resistance of the aqueous inkjet ink can be further increased.

The pigment is not particularly limited, and either of an inorganic pigment and an organic pigment may be used. Examples of the inorganic pigment include titanium oxide and iron oxide. Further, a carbon black produced by a known method such as a contact method, a furnace method, or a thermal method can be used.

As the organic pigment, for example, an azo pigment (such as an azo lake pigment, an insoluble azo pigment, a condensed azo pigment, or a chelate azo pigment), a polycyclic pigment (such as a phthalocyanine pigment, a perylene pigment, a perinone pigment, an anthraquinone pigment, a quinacridone pigment, a dioxazine pigment, a thioindigo pigment, an isoindolinone pigment, or a quinophthalone pigment), a dye chelate (such as a basic dye type chelate, or an acid dye type chelate), a nitro pigment, a nitroso pigment, aniline black, or the like can be used.

Specific examples of the carbon black which is used as a black ink include No. 2300, No. 900, MCF88, No. 33, No. 40, No. 45, No. 52, MA7, MA8, MA100, and No. 2200B (all of which are manufactured by Mitsubishi Chemical Corporation), Raven 5750, Raven 5250, Raven 5000, Raven 3500, Raven 1255, and Raven 700 (all of which are manufactured by Columbian Chemicals Company), Regal 400R, Regal 330R, Regal 660R, Mogul L, Monarch 700, Monarch 800, Monarch 880, Monarch 900, Monarch 1000, Monarch 1100, Monarch 1300, and Monarch 1400 (all of which are manufactured by Cabot Corporation), and Color Black FW1, Color Black FW2, Color Black FW2V, Color Black FW18, Color Black FW200, Color Black S150, Color Black S160, Color Black S170, Printex 35, Printex U, Printex V, Printex 140U, Special Black 6, Special Black 5, Special Black 4A, and Special Black 4 (all of which are manufactured by Degussa AG).

Specific examples of the pigment which is used in a yellow ink include C.I. Pigment Yellow 1, C.I. Pigment Yellow 2, C.I. Pigment Yellow 3, C.I. Pigment Yellow 12, C.I. Pigment Yellow 13, C.I. Pigment Yellow 14C, C.I. Pigment Yellow 16, C.I. Pigment Yellow 17, C.I. Pigment Yellow 73, C.I. Pigment Yellow 74, C.I. Pigment Yellow 75, C.I. Pigment Yellow 83, C.I. Pigment Yellow 93, C.I. Pigment Yellow 95, C.I. Pigment Yellow 97, C.I. Pigment Yellow 98, C.I. Pigment Yellow 109,

C.I. Pigment Yellow 110, C.I. Pigment Yellow 114, C.I. Pigment Yellow 128, C.I. Pigment Yellow 129, C.I. Pigment Yellow 138, C.I. Pigment Yellow 150, C.I. Pigment Yellow 151, C.I. Pigment Yellow 154, C.I. Pigment Yellow 155, C.I. Pigment Yellow 180, and C.I. Pigment Yellow 185.

Specific examples of the pigment which is used in a magenta ink include C.I. Pigment Red 5, C.I. Pigment Red 7, C.I. Pigment Red 12, C.I. Pigment Red 48(Ca), C.I. Pigment Red 48(Mn), C.I. Pigment Red 57(Ca), C.I. Pigment Red 57:1, C.I. Pigment Red 112, C.I. Pigment Red 122, C.I. Pigment Red 123, C.I. Pigment Red 168, C.I. Pigment Red 184, C.I. Pigment Red 202, and C.I. Pigment Violet 19.

Specific examples of the pigment which is used in a cyan ink include C.I. Pigment Blue 1, C.I. Pigment Blue 2, C.I. Pigment Blue 3, C.I. Pigment Blue 15:3, C.I. Pigment Blue 15:4, C.I. Pigment Blue 15:34, C.I. Pigment Blue 16, C.I. Pigment Blue 22, C.I. Pigment Blue 60, C.I. Vat Blue 4, and C.I. Vat Blue 60.

Since the ink is an inkjet ink, it is preferred that the average particle diameter of such a pigment is within a range of about 10 to 300 nm. It is more preferred that the average particle diameter of the pigment is within a range of about 10 to 200 nm.

The average particle diameter of the pigment can be determined using a particle size distribution analyzer by means of a dynamic light scattering method. Examples of the particle size distribution analyzer include HPPS (Malvern Instruments Ltd.).

The pigment can be used in a state of a pigment dispersion. The pigment dispersion can be prepared by, for example, dispersing the pigment in water or an alcohol with a dispersant. Examples of the dispersant include a surfactant, a water-soluble resin, and a water-insoluble resin. Alternatively, a self-dispersible pigment may be used. The self-dispersible pigment is a pigment which can be dispersed in water or the like without using a dispersant, and to which at least one functional group selected from a carbonyl group, a carboxyl group, a hydroxyl group, and a sulfone group or a salt thereof is bound through a surface treatment. Examples of the surface treatment include a vacuum plasma treatment, a diazo coupling treatment, and an oxidation treatment. The self-dispersible pigment is obtained by grafting a functional group or a molecule containing a functional group on the surface of a pigment through such a surface treatment.

The content of the pigment in the ink is preferably within a range of 2 to 20% by mass of the total amount of the ink. If the content of the pigment is within this range, a printed matter having a necessary image density can be formed without causing any disadvantage with respect to the storage stability or ejection performance of the ink.

The pigment dispersion is mixed with the liquid mixture containing water (first liquid) and the water activity decreasing agent (second and third liquids), whereby the aqueous inkjet ink according to this embodiment is prepared.

Since the ink according to this embodiment is for use in inkjet printing, it is necessary that the ink have a viscosity suitable for ejection from a nozzle of a head in an inkjet printer. Specifically, the viscosity of the ink at 25° C. is preferably from 3 to 15 mPa·s.

In order to adjust the ejection performance, moisture-retaining property, storage stability, physical properties, and the like of the aqueous inkjet ink to be within an optimal range, a surfactant, a moisture-retaining agent, a resin, or the like may be additionally blended in the ink within a range that does not deteriorate the effect.

Examples of the surfactant include polyoxyethylene alkyl ethers, polyoxyalkylene alkyl ethers, polyoxyethylene polycyclic phenyl ethers, polyoxyalkylene polycyclic phenyl ethers, and glycerin fatty acid esters.

Further, an acetylene glycol-based surfactant, a fluorine-based surfactant, or a nonionic surfactant can also be used. Examples of the acetylene glycol-based surfactant include 2,4,7,9-tetramethyl-5-decyne-4,7-diol, 3,6-dimethyl-4-octyne-3,6-diol, and 3,5-dimethyl-1-hexyn-3-ol. Specific examples thereof include Surfynol 104, Surfynol 82, Surfynol 465, Surfynol 485, and Surfynol TG (all of which are manufactured by Air Products, Inc.).

Examples of the fluorine-based surfactant include perfluoroalkyl ethylene oxide adducts, perfluoroalkyl amine oxides, perfluoroalkyl carboxylates, and perfluoroalkyl sulfonates. Specific examples thereof include Megafac F-443, Megafac F-444, Megafac F-470, and Megafac F-494 (all of which are manufactured by Dainippon Ink Chemical Industry, Co., Ltd.), Novec FC-430 and Novec FC-4430 (all of which are manufactured by 3M Co., Ltd.), and Surflon S-141, Surflon S-145, Surflon S-111N, and Surflon S-113 (all of which are manufactured by Seimi Chemical Co., Ltd.).

Examples of the nonionic surfactant include polyoxyethylene alkyl ethers, polyoxyethylene alkyl esters, polyoxyethylene sorbitan fatty acid esters, polyoxyethylene alkylphenyl ethers, polyoxyethylene alkylamines, and polyoxyethylene alkylamides.

It is desired that such a surfactant is added to such an extent that the addition thereof does not deteriorate the dispersion stability and the like of the ink. The surfactant can exhibit an effect without causing any disadvantage as long as the surfactant is contained in an amount of from about 0.5 to 2.0% by mass of the total amount of the ink.

Among the above-mentioned surfactants, for example, an acetylene glycol-based surfactant, a nonionic surfactant, or the like can be used as a dispersant for preparing the pigment dispersion.

According to need, an additive such as a pH adjusting agent or an antiseptic or antifungal agent can be blended in the ink. Examples of the pH adjusting agent include potassium dihydrogen phosphate, disodium hydrogen phosphate, and sodium hydroxide.

As the antiseptic or antifungal agent, for example, sodium benzoate, sodium pentachlorophenol, sodium 2-pyridinethiol-1-oxide, sodium sorbate, sodium dehydroacetate, 1,2-dibenzisothiazolin-3-one (Proxel CRL, Proxel BDN, Proxel GXL, Proxel XL-2, or Proxel TN, (all of which are manufactured by Imperial Chemical Industries Limited), or the like can be used.

By blending such an additive, the print image quality or storage stability can be further increased.

Hereinafter, specific examples of the aqueous inkjet ink will be shown.

As the compound represented by the general formula (PEG), PEG200 (manufactured by Sanyo Chemical Industries, Ltd.), PEG400 (manufactured by Sanyo Chemical Industries, Ltd.), MPG (manufactured by Nippon Nyukazai Co., Ltd.) and MTG (manufactured by Nippon Nyukazai Co., Ltd.) were prepared.

R^{a}—O—(CH₂CH₂O)ₙ—H (PEG)

PEG200 and PEG400 are compounds in which H is introduced in the above general formula as R^{a}. The weight average molecular weights of PEG200 and PEG400 are 200 and 400, respectively. MPG and MTG are compounds in which CH₃ is introduced in the above general formula as R^{a}.

Further, as the compound represented by the general formula (PGC), SC-P400 (manufactured by Sakamoto Yakuhin Kogyo Co., Ltd.) and SC-E450 (manufactured by Sakamoto Yakuhin Kogyo Co., Ltd.) were prepared.

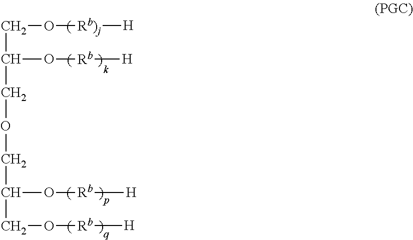

SC-P400 is a compound in which CH₂CHCH₃O is introduced in the above general formula as R^{b}. The value of j+k+p+q is nearly 4, and the weight average molecular weight thereof is 400.

SC-E450 is a compound in which CH₂CH₂O is introduced in the above general formula as R^{b}. The value of j+k+p+q is nearly 7, and the weight average molecular weight thereof is 450.

By using pure water as the first liquid, propylene glycol as the second liquid, and a given third liquid, the respective components were blended according to the formulation shown in the following Table 1, whereby an ink sample was prepared. In the table, the amount of each component is expressed in % by mass of the total amount of the inkjet ink. As for the third liquid, the name and the amount (% by mass) are shown in the table.

As the surfactant, Surfynol 465 (manufactured by Nissin Chemical Industry CO., Ltd.) was used.

As the pigment, a self-dispersible pigment dispersion was used. Specifically, a carbon black dispersion liquid CAB-JET-300 (manufactured by Cabot Corporation) was used. In this pigment dispersion, a carbon black is dispersed in water. The average particle diameter of the pigment is about 120 nm. The amount of water contained in the pigment dispersion is included in the amount of water in the following Table 1.

As shown in the following Table 1, in all of the samples, the pigment dispersion was blended in an amount such that the solid content of the pigment was 6.5% by mass of the total amount of the ink.

In the preparation of each ink sample, the respective components were mixed according to the formulation shown in the table, and the resulting mixture was stirred for 1 hour using a stirrer. Thereafter, the mixture was filtered through a 1-μm membrane filter, whereby the sample was obtained.

TABLE 1

| No. | 1st liq. | 2nd liq. | 3rd liq. | Surfactant | Pigment |
|---|---|---|---|---|---|
| 1 | 56.5 | 27 | PEG200 (9) | 1 | 6.5 |
| 2 | 56.5 | 18 | PEG200 (18) | 1 | 6.5 |
| 3 | 46.5 | 37 | PEG200 (9) | 1 | 6.5 |
| 4 | 46.5 | 28 | PEG200 (18) | 1 | 6.5 |
| 5 | 56.5 | 27 | PEG400 (9) | 1 | 6.5 |
| 6 | 56.5 | 18 | PEG400 (18) | 1 | 6.5 |
| 7 | 46.5 | 37 | PEG400 (9) | 1 | 6.5 |
| 8 | 46.5 | 28 | PEG400 (18) | 1 | 6.5 |
| 9 | 56.5 | 0 | PEG200 (36) | 1 | 6.5 |
| 10 | 46.5 | 0 | PEG200 (46) | 1 | 6.5 |
| 11 | 56.5 | 27 | SC-P400 (9) | 1 | 6.5 |
| 12 | 46.5 | 37 | SC-P400 (9) | 1 | 6.5 |
| 13 | 46.5 | 37 | SC-E450 (9) | 1 | 6.5 |
| 14 | 46.5 | 28 | SC-E450 (18) | 1 | 6.5 |
| 15 | 46.5 | 37 | MPG (9) | 1 | 6.5 |
| 16 | 46.5 | 37 | MTG (9) | 1 | 6.5 |
| 17 | 46.5 | 28 | MPG (18) | 1 | 6.5 |
| 18 | 46.5 | 28 | MTG (18) | 1 | 6.5 |

For each of the obtained ink samples, the water activity and the viscosity were measured. The water activity was measured at 25° C. using Aqua Lab CX-3TE (manufactured by DECAGON Co.).

The viscosity was measured using a cone-plate type viscometer, VISCOMETER TV-22 (manufactured by Toki Sangyo Co., Ltd.) with a cone rotor (0.8°×R24) under the condition of 25° C. and 20 rpm.

The water activity and viscosity of each ink sample are summarized in the following Table 2.

TABLE 2

| No. | Water activity | Viscosity (mPa · s) |
|---|---|---|
| 1 | 0.84 | 6.4 |
| 2 | 0.86 | 6.8 |
| 3 | 0.75 | 13.2 |
| 4 | 0.77 | 13.5 |
| 5 | 0.89 | 8.5 |
| 6 | 0.90 | 9.0 |
| 7 | 0.77 | 14.6 |
| 8 | 0.80 | 14.8 |
| 9 | 0.95 | 6.25 |
| 10 | 0.88 | 9.83 |
| 11 | 0.84 | 7.4 |
| 12 | 0.77 | 12.1 |
| 13 | 0.76 | 10.8 |
| 14 | 0.78 | 12.9 |
| 15 | 0.73 | 10.4 |
| 16 | 0.73 | 10.5 |
| 17 | 0.76 | 13.5 |
| 18 | 0.75 | 13.7 |

For each of the obtained ink samples, performance of suppressing curling of paper was examined. The evaluation method is as follows.

Solid printing was performed on plain paper at a 100% duty using an inkjet printing apparatus provided with a piezoelectric head CF1 manufactured by Toshiba Tec Corporation. As the plain paper, Toshiba Copy Paper was used. The paper after printing was placed on a flat desk, and after 1 minute, the height of each of the four corners of the paper lifted from the surface of the desk was measured. The height of curl was evaluated based on the following evaluation criteria.

A: less than 5 mm

B: 5 mm or more but less than 10 mm

C: 10 mm or more

If the height of curl is less than 10 mm, there is no problem from a practical viewpoint, and therefore, the paper can be evaluated to have favorable curling suppressing performance.

Further, the presence or absence of deformation of paper immediately after printing by an actual apparatus was evaluated based on the paper conveying performance. By using the above-mentioned inkjet printing apparatus, a solid image was formed on the same plain paper as described above. In order to form one pixel, 3 droplets of 4 pl (picoliter) of the ink were continuously ejected from one nozzle and allowed to land on the same position. The solid image was formed at 600 dpl (dots per inch) on the entire surface of one side of the paper.

The paper conveying performance was evaluated based on the following criteria. The case where the paper can be conveyed is acceptable.

A: A paper jam is not caused and the paper can be conveyed.

B: The paper is not neatly discharged, but can be conveyed.

C: The paper cannot be conveyed due to a paper jam.

The evaluation results of the paper conveying performance are summarized in the following Table 3 along with the curling suppressing performance.

TABLE 3

| | Curling suppressing | Paper conveying |
|---|---|---|
| No | performance | performance |
| 1 | B | B |
| 2 | C | B |
| 3 | A | A |
| 4 | B | B |
| 5 | C | C |
| 6 | C | C |
| 7 | B | B |
| 8 | B | B |
| 9 | C | C |
| 10 | C | C |
| 11 | B | B |
| 12 | B | B |
| 13 | A | A |
| 14 | B | B |
| 15 | A | A |
| 16 | A | B |
| 17 | B | B |
| 18 | A | B |

As shown in the above Table 3, No. 1, No. 3, No. 4, No. 7, No. 8, and No. 11 to No. 18 ink samples exhibit favorable curling suppressing performance, and also exhibit acceptable paper conveying performance. It is shown in the above Table 2 that all of these ink samples have a water activity of 0.85 or less. In particular, the results of No. 3 and No. 15 ink samples show that when the water activity is 0.75 or less, both of the curling suppressing performance and the paper conveying performance are evaluated as A.

Further, the results of No. 2, No. 5, No. 6, No. 9, and No. 10 ink samples show that when the water activity is 0.86 or more, curling of paper cannot be suppressed.

The aqueous inkjet ink according to this embodiment can form an image on a paper medium without causing deformation of the paper medium such as curling or cockling.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An aqueous inkjet ink comprising:
a color material;
water as a first liquid;
propylene glycol as a second liquid; and
a compound represented by the following general formula (PEG) or a compound represented by the following general formula (PGC) as a third liquid, the ink having a water activity of 0.85 or less:
R^{a}—O—(CH₂CH₂O)ₙ—H (PEG)
wherein R^{a} represents H or CH₃; and n represents 3 to 14, 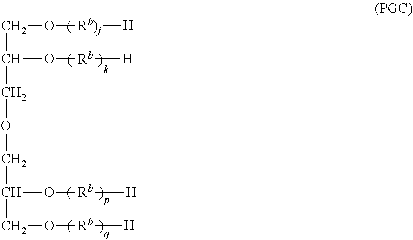
wherein R^{b} represents a group selected from CH₂CH₂O and CH₂CHCH₃O; and j, k, p, and q may be the same or different, and represent an integer of 1 or more, and satisfy the formula: 4≦j+k+p+q≦8.

2. The ink according to claim 1, wherein the third liquid is a compound represented by the general formula (PEG).

3. The ink according to claim 2, wherein an amount of the first liquid is from 40 to 60% by mass of a total amount of the ink.

4. The ink according to claim 2, wherein an amount of the second liquid is from 25 to 40% by mass of a total amount of the ink.

5. The ink according to claim 2, wherein an amount of the compound represented by the general formula (PEG) is from 5 to 20% by mass of a total amount of the ink.

6. The ink according to claim 5, wherein the amount of the compound represented by the general formula (PEG) is from 9 to 20% by mass of the total amount of the ink.

7. The ink according to claim 2, wherein the compound represented by the general formula (PEG) has a weight average molecular weight of 400 or less.

8. The ink according to claim 2, wherein the ink has a water activity of 0.75 or less.

9. The ink according to claim 2, wherein the color material is a self-dispersible pigment.

10. The ink according to claim 1, wherein the third liquid is a compound represented by the general formula (PGC).

11. The ink according to claim 10, wherein an amount of the first liquid is from 40 to 60% by mass of a total amount of the ink.

12. The ink according to claim 10, wherein an amount of the second liquid is from 25 to 40% by mass of a total amount of the ink.

13. The ink according to claim 10, wherein an amount of the compound represented by the general formula (PGC) is from 5 to 20% by mass of a total amount of the ink.

14. The ink according to claim 13, wherein the amount of the compound represented by the general formula (PGC) is from 9 to 20% by mass of the total amount of the ink.

15. The ink according to claim 10, wherein the ink has a water activity of 0.75 or less.

16. The ink according to claim 10, wherein the color material is a self-dispersible pigment.

17. A method for inkjet printing comprising:
ejecting at least one type of ink composition from an inkjet head onto a paper medium to form an image, the ink composition being the inkjet ink according to claim 1.

18. The method according to claim 17, wherein the image is formed using one type of ink composition.

19. The method according to claim 17, wherein the image is formed using two or more types of ink compositions of different colors.
